(19) United States
(12) Patent Application Publication
(10) Pub. No.: US 2003/0164967 A1
(43) Pub. Date: Sep. 4, 2003

(54) Image processing method, image processing apparatus, and image processing program

(75) Inventor: Masashi Norimatsu, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/369,196

(22) Filed: Feb. 20, 2003

(30) Foreign Application Priority Data
Feb. 20, 2002 (JP) 2002-043196

(51) Int. Cl. H04N 1/409; G06T 5/00; G06K 15/02

(52) U.S. Cl. 358/1.9; 358/1.6; 358/3.24; 358/3.27

(57) ABSTRACT

The image processing method acquires image data from an image data supply source, subjects the thus acquired image data to a first image structure processing scheme that has been set in accordance with characteristics of the image data supply source and thereafter subjects the thus subjected image data to a second image structure processing scheme that has been set in accordance with characteristics of an output site to which said image data subjected to the second image structure processing scheme is delivered. The image processing apparatus and image processing program implement the image processing method.

### BACKGROUND OF THE INVENTION

This invention relates to the image processing art involving the processing of image data. More particularly, the invention relates to an image processing method, an image processing apparatus and an image processing program, each making it possible to output an image of the appropriate structure irrespective of where image data is input from or of where it is eventually output to.

In the state of the art, the images recorded on negative film, reversal film and other photographic films (hereunder referred to simply as films) are commonly printed on light-sensitive materials (photographic paper) by the so-called “direct exposure” technique in which the image on the film is projected onto the light-sensitive material.

An alternative approach has recently been proposed and put to commercial use as a digital photoprinter; the image recorded on a film is captured photoelectrically and the obtained signals are converged to digital signals, which are subjected to various image processing schemes in order to generate recording image data, and a light-sensitive material is exposed to recording light modulated in accordance with the recording image data so that it is eventually output as a print.

In the digital photoprinter, the photoelectrically captured image is subjected to image processing as digital image data, so the colors and densities of the image to be reproduced on the print can be corrected in a desired way. In addition, a sharpening process which suppresses the granularity of the film and adjusts sharpness to the appropriate level in order to provide an image with a satisfactory structure and any other image processing schemes that are inherently impossible to perform by the conventional, direct-exposure printer can be implemented to produce high-quality image.

The digital photoprinter not only outputs image on the print; the image data for the image reproduced on the print can also be output as an image file to various recording media such as CD-R and MO (magneto-optical recording medium).

Photographic films are not the only source of image input to the digital photoprinter; it may also receive the image data from a digital camera (recording medium loaded thereon) or recording media such as CD-R to which the data was previously output, and may subsequently output a print as it reproduces the image carried by that image data.

The basic components of the digital photoprinter are: a scanner (image reader) that photoelectrically captures the image recorded on the film; an image processor that performs various image processing schemes on the image data captured by the scanner to generate output image data; and a printer-processor including a printer (printing unit) that receives the image data processed in the image processor and exposes the photographic paper to recording light (such as laser beams) modulated in accordance with this image data and a processor (developing unit) that performs development and other treatments on the photographic paper exposed by the printer so that it is eventually output as a (finished) print.

The image processor has a media drive and an interface for capturing image data from a recording medium or outputting image data to another recording medium as an image file after it has been subjected to image processing schemes.

With the existing digital photoprinters, the image data to be eventually output to a recording media are basically the same as the image data to be output as a print. Both data undergo the sharpening process. However, the image to be reproduced on a print and the image to be represented on a display differ in the parameters that are optimum to the sharpening process and the image that is output to a recording medium will appear grainy if it is represented on a display.

The digital photoprinter may acquire image data other than from the scanner equipped as a standard accessory; image data may be captured with a scanner of reflection documents or a scanner of a different model; alternatively, image data may be processed with a different system and later stored on a recording medium such as CD-R; these image data are also supplied to the image processor where they are processed to be eventually output as a print or an image file.

In another situation, the image data processed with the image processor may be output to an optional printer such as an ink-jet printer (i.e. other than the printer-processor equipped as a standard accessory) in order to create a print; it may alternatively be output as an image file of a format that is compatible with a different system.

In fact, however, the scanner and the digital camera output images of different structures. Even in the case of the scanner, different models output images having different structures in one or more aspects including sharpness. Further, the parameters optimum to the sharpening process differ depending upon where the image is eventually output to (e.g. a display or a printer), as well as on the type of printer or the model of the printer-processor.

As a result, the existing digital photoprinters often fail to produce images of optimum structures depending upon where the image data is supplied from or where it is eventually output to.

### SUMMARY OF THE INVENTION

The present invention has been accomplished under these circumstances and has as an object providing an image processing method, an image processing apparatus and an image processing program, in each of which image data is acquired and subjected to image structure processing for subsequent outputting and each of which makes it possible to output an image of the appropriate structure, namely, an image having less noise, suppressed graininess and satisfactory sharpness irrespective of where the image is supplied from and where it is eventually output to.

In order to attain the object described above, the first aspect of the present invention provides an image processing method, comprising the steps of: acquiring image data from an image data supply source; subjecting the thus acquired image data to a first image structure processing scheme that has been set in accordance with characteristics of said image data supply source; and thereafter subjecting the thus subjected image data to a second image structure processing scheme that has been set in accordance with characteristics of an output site to which said image data subjected to the second image structure processing scheme is eventually delivered.

Preferably, said first image structure processing scheme is an image structure processing scheme by which an image carried by said acquired image data is converted to an intermediate image having a specified image structure.

Preferably, said intermediate image is an image having an image structure compatible with a preliminarily chosen output site.

Preferably, said intermediate image is an image obtained by removing a noise component or graininess derived from said image data supply source, an image obtained by converting an MTF (Modulation Transfer Function) characteristic of said image data supply source so that it may match a reference intermediate MTF characteristic which is preliminarily set, or an image obtained by removing the noise component or graininess derived from said image data supply source and, concurrently therewith, converting the MTF characteristic of said image data supply source so that it may match the reference intermediate MTF characteristic which is preliminarily set.

Preferably, said first image structure processing scheme includes removal of a noise component derived from said image data supply source.

Preferably, said image data supply source is a scanner for capturing an image recorded on a photographic film, said image data is image data captured with said scanner from said image recorded on a photographic film, and said noise component is graininess.

Preferably, said first image structure processing scheme includes frequency processing in which an MTF characteristic of said image data supply source is converted so that it may match a reference intermediate MTF characteristic which is preliminarily set.

Preferably, in said first image structure processing scheme, a noise component or graininess derived from said image data supply source is removed and, concurrently therewith, frequency processing is so performed that an MTF characteristic of said image data supply source is converted so that it may match a reference intermediate MTF characteristic which is preliminarily set.

Preferably, said second image structure processing scheme includes frequency processing in which an output MTF characteristic is calculated from a reference output MTF characteristic which is preliminarily set, an MTF characteristic of said output site, and viewing conditions and a reference intermediate MTF characteristic which is preliminarily set is converted so that it may match the output MTF characteristic thus calculated.

Preferably, said viewing conditions include output size and viewing distance.

In order to attain the object described above, the second aspect of the present invention provides an image processing apparatus comprising: image data acquiring means for acquiring image data from an image data supply source; first image structure processing means for subjecting the image data acquired with the image data acquiring means to a first image structure processing scheme that has been set in accordance with characteristics of said image data supply source; and second image structure processing means for subjecting the image data subjected to said first image structure processing scheme by the first image structure processing means to a second image structure processing scheme that has been set in accordance with characteristics of an output site to which said image data subjected to the second image structure processing scheme is eventually delivered.

Preferably, said first image structure processing means converts an image carried by said acquired image data to an intermediate image having a specified image structure.

Preferably, said first image structure processing means removes a noise component or graininess derived from said image data supply source.

Preferably, said first image structure processing means performs frequency processing in which an MTF characteristic of said image data supply source is converted so that it may match a reference intermediate MTF characteristic which is preliminarily set.

Preferably, said second image structure processing means performs frequency processing in which an output MTF characteristic is calculated from a reference output MTF characteristic which is preliminarily set, an MTF characteristic of said output site, and viewing conditions and a reference intermediate MTF characteristic which is preliminarily set is converted so that it may match the output MTF characteristic thus calculated.

In order to attain the object described above, the third aspect of the present invention provides an image processing program for implementing the image processing method of the first aspect of the present invention.

### BRIEF DESCRIPTION OF THE DRAWINGS

FIG. 1 is a block diagram for an exemplary digital photoprinter in which the image processing method of the present invention is implemented;

FIG. 2 is a block diagram for an exemplary image processor in the digital photoprinter depicted in FIG. 1;

FIG. 3 shows in concept the sharpening process that is performed in the image processing method of the present invention; and

FIG. 4 is a block diagram for an example of the sharpening section in the image processor depicted in FIG. 2.

### DETAILED DESCRIPTION OF THE INVENTION

The image processing method, the image processing apparatus and the image processing program of the invention are described below in detail with reference to the preferred embodiments shown in the accompanying drawings.

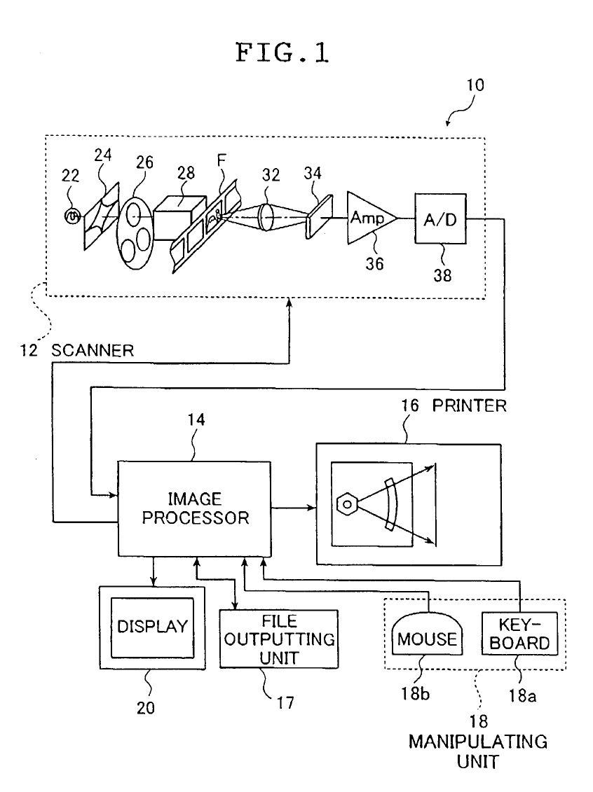

FIG. 1 is a block diagram for an exemplary digital photoprinter that utilizes the image processing apparatus according to the second aspect of the present invention for implementing the image processing method according to the first aspect of the present invention. The digital photoprinter (hereunder referred to simply as photoprinter) 10 shown in FIG. 1 comprises basically a scanner (image reader) 12, an image processor 14, a printer (printing and developing unit) 16 and a file outputting unit (media drive) 17.

Also connected to the image processor 14 are a manipulating unit 18 having a keyboard 18a and a mouse 18b for inputting or setting various instructions, selecting and commanding a specific image processing step and entering a command and so forth for effecting color/density correction, as well as a display 20 for representing simulated images for monitoring purposes and commanding manipulation by GUI.

The scanner 12 is a device with which the images recorded on a film F are captured photoelectrically frame by frame. In other words, the scanner 12 is a film scanner. It comprises a white light source 22, a variable diaphragm 24, a color filter plate 26, a diffuser box 28 which diffuses the reading light incident on the film F so that it becomes uniform across the plane of the film F, an imaging lens unit 32, an area CCD sensor (hereunder referred to simply as CCD sensor) 34, an amplifier (Amp) 36 and an A/D (analog-to-digital) converter 38.

The scanner 12 captures the images on the film F in the following manner: the reading light from the light source 22 has its quantity adjusted by means of the variable diaphragm 24, conditioned by passage through the color filter plate 26 and diffused through the diffuser box 28; the diffused reading light is then incident on the film F held in a specified reading position by means of a carrier and thereafter passes through the film F to produce projection light bearing the image recorded on the film F.

The projection light passes through the imaging lens unit 32 to be focused for imaging on the light-receiving plane of the CCD sensor 34, whereby the image recorded on the film F is captured photoelectrically.

Output signals from the CCD sensor 34 are amplified with the Amp 36, converted to digital signals by the A/D converter 38 and then forwarded to the image processor 14.

The color filter plate 26 is a turret having red (R), green (G) and blue (8) color filters which is turned by a known means so that the respective color filters are inserted into the optical path of the reading light. In the illustrated scanner 12, the respective color filters of the plate 26 are sequentially inserted into the optical path and image capturing is performed three times, whereby the image recorded on the film F is captured as it has been separated into three primary colors R, G and B.

In the scanner 12, the images recorded on the film F are captured by two scans, the first being “prescan” at low resolution and the second being “fine scan” for obtaining image data that is compatible with the outputting of a print or an image file. Prescan is performed under preset prescan-associated conditions which ensure that the images on all films to be handled by the scanner 12 can be captured without saturating the CCD sensor 34. Fine scan is performed under conditions that are set for each frame in accordance with the prescanned data and the output size of the image to be delivered from the image processor 14. Therefore, the output signals for prescan and fine scan are essentially the same data except for resolution in image capturing and output levels.

The image capturing scanner 12 used in the invention is by no means limited to the illustrated example and various known types of scanner may be employed. For example, it may be a scanner that captures an image in three separated primary colors using such a light source as composed of the LEDs that issue the reading light beams in three primary colors, respectively. Yet another scanner that may be employed is of a type that performs slit. scan reading using tri-color line CCD sensors.

As already mentioned, the output signals (image data) from the scanner 12 are delivered to the image processor 14.

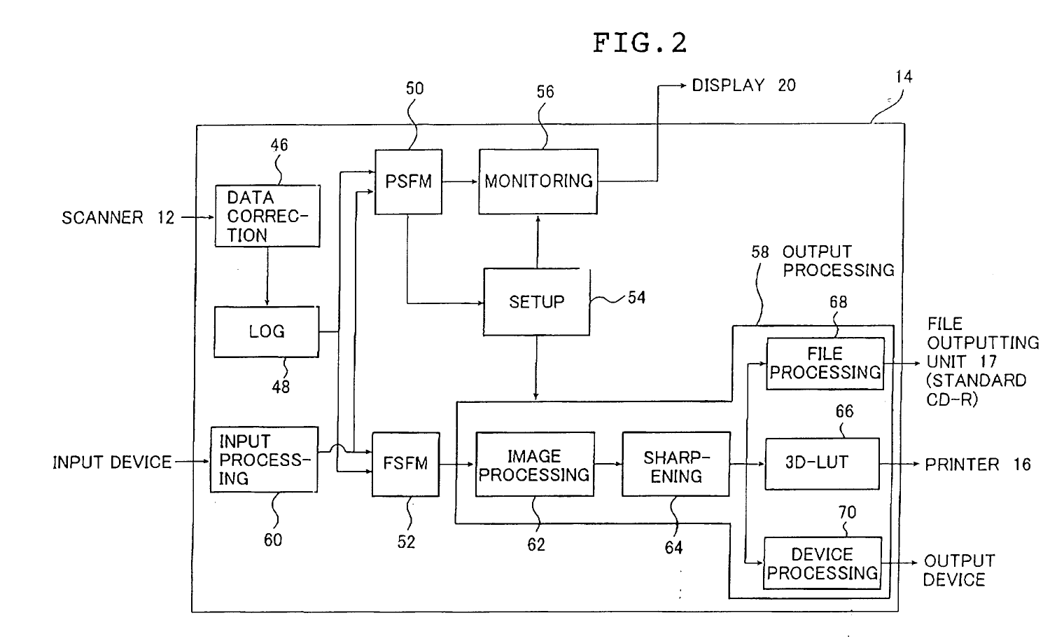

FIG. 2 is a block diagram of the image processor 14. As shown, the image processor (hereunder referred to simply as processor) 14 comprises a data correcting unit 46, a log converter 48, a prescan frame memory (hereunder referred to simply as PSFM) 50, a fine scan frame memory (hereunder referred to simply as FSFM) 52, a setup unit 54, a monitoring unit 56, an output processing unit 58 and an input processing unit 60.

FIG. 2 shows only the sites related to image processing. The processor 14 also controls and manages the overall operation of the photoprinter 10 as by operating various sites in accordance with an entered method of outputting. Hence, in addition to the sites shown in FIG. 2, the processor 14 includes a CPU for overall control, memories for storing the information necessary for the operation and otherwise of the photoprinter 10, etc.

Although not shown, the image processor 14 further includes a media drive and an interface for acquiring image data from various input devices to be described later. The media drive functioning as the file outputting unit 17 may also be used as an input device for inputting image data read from various recording media.

The data correcting unit 46 is a site where specified processing steps including DC offset correction, dark current correction and shading correction are applied to the R, G and B output data as they are supplied from the scanner 12.

The log converter 48 is a site where the output data processed in the data correcting unit 46 are subjected to logarithmic conversion by a suitable means such as LUTs (look-up tables) so that they are converted to digital image (density) data. The prescanned (image) data from the log converter 48 is stored in SFM 50 and the fine scanned (image) data is stored in FSFM 52.

The photoprinter 10 is so designed that it can acquire image data not only from the scanner 12 equipped as a standard accessory but also another model of film scanner, a scanner for reflective-type originals, a digital camera, or a media drive adapted for such a recording medium as a CD-R (standard CD-R to be described later) in which image data previously output by the photoprinter 10 or other systems (including a digital camera) is stored (such devices including the scanner 12 being hereunder collectively referred to as input devices), then process the acquired image data for subsequent outputting. The input devices of the present invention, that is, the scanner 12 and other input devices are image data supply sources.

The image data acquired from such input devices are sent to the input processing unit 60, in which the image data are subjected to necessary processing steps such as expanding of compressed data, color space transformation and electronic scaling (enlargement and reduction), whereby the image data are converted to those compatible with the image processor 14 (prescanned data and fine scanned data) and sent to PSFM 50 and FSFM 52.

Using the prescanned data stored in PSFM 50, the setup unit 54 determines the reading conditions for fine scan as well as the conditions for image processing in the monitoring unit 56 and the output processing unit 58 (in particular, an image processing section 62) If the image color/density, etc. are modified by monitoring, the setup unit 54 responds to the modification by, for example, determining the image processing conditions or modifying the previously determined image processing conditions.

The setup unit 54 may determine the image processing conditions by any known methods using image analysis and the like in accordance with the specific image processing scheme to be implemented. If desired, those image processing conditions which are uniquely determined in accordance with the size of input image, the size of output image and other factors may be preliminarily stored in tabulated form.

The monitoring unit 56 is a site where in accordance with the image processing conditions determined by the setup unit 54, the prescanned data is subjected to image processing and converted to image data compatible with image representation on the display 20, so that it is represented on the display 20 as an image that simulates a finished state (image for monitoring).

Note that the display 20 is not limited to any particular type and various known types of display means can be employed, as exemplified by a CRT (cathode-ray tube) display, a liquid-crystal display (LCD) and a plasma display panel (PDP).

The output processing unit 58 comprises the image processing section 62, a sharpening section 64, a data converting section 66, a file processing section 68 and a device processing section 70.

The image processing section 62 is a site where various image processing schemes are performed on the fine scanned data in accordance with the image processing conditions determined by the setup unit 54. The image processing schemes to be performed in the image processing section 62 are not limited to any particular types and may be exemplified by color/density correction, tone conversion, color balance correction, saturation correction, and dodging (conferring an effect corresponding to the dodging effect in a direct exposure print by image data processing). These image processing schemes may be accomplished by known methods using look-up tables (LUTs), matrix (MTX) operations, low-pass filters (LPFs), etc.

The sharpening section 64 is one of the sites for implementing the image processing method of the invention, where the image structure processing schemes compatible with the input and those compatible with the output as well, each characterizing the present invention, are performed. In the following, the image structure processing is exemplified by the sharpening process although the present invention is in no way limited thereto. Examples of the image structure processing schemes which may be performed in the present invention include, apart from the sharpening process, noise removal and frequency processing.

The image structure processing schemes compatible with the input that are to be performed in the sharpening section 64 include the removal of the noise component derived from an input device, namely an image data supply source, such as graininess in the case of the image captured with a scanner from a film image, and such frequency processing as to convert the MTF (Modulation Transfer Function) characteristic of an input device so that it may match the reference intermediate MTF characteristic which is preliminarily set. Preferably, the removal of the noise component or graininess and the frequency processing are performed concurrently with each other.

The image structure processing schemes compatible with the output that are to be performed in the sharpening section 64 include such frequency processing as to calculate an output MTF characteristic from the reference output MTF characteristic which is preliminarily set, the MTF characteristic of an output device, and viewing conditions (output size and viewing distance) and convert the reference intermediate MTF characteristic so that it may match the output MTF characteristic thus calculated.

It should be noted that an image structure processing scheme compatible with the input provides an intermediate image having a specified image structure, which is an image obtained by removing the noise component (graininess) derived from an input device, by converting the MTF characteristic of an input device so that it may match the reference intermediate MTF characteristic which is preliminarily set, or again, by performing such removal and frequency processing as above concurrently with each other.

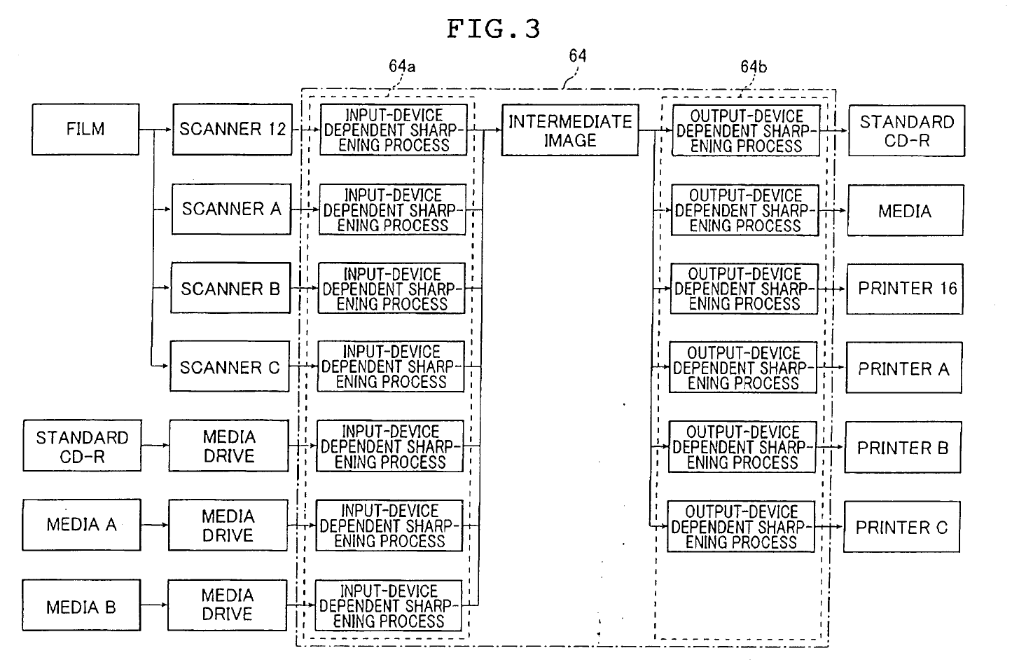

In the illustrated case, the sharpening section 64 comprises a first sharpening device 64a and a second sharpening device 64b (see FIG. 3) and performs a sharpening process (that is, image structure processing) on the image data with the first sharpening device 64a in a way compatible with the image data supply source such as scanner 12, whereby the input image is converted to an intermediate image having a specified image structure; the sharpening section 64 then performs a sharpening process (that is, image structure processing) on the intermediate image with the second sharpening device 64b in accordance with the device such as the printer 16 to which the final image is to be output, with the sharpened intermediate image being sent to the next stage. Further details of the configuration and function of the sharpening section 64 are given later.

In the illustrated case, the sharpening section 64 is positioned downstream of the image processing section 62. This is not the sole case of the invention and the sharpening section 64 may be located upstream of the image processing section 62 or, alternatively, sharpening may be performed in the course of image processing by the image processing section 62 which is provided with the sharpening section 64.

The data converting section 66 is a site where image data conversion is effected to provide compatibility with image recording by the printer 16 and the resulting image data is output to the printer 16.

Note that the printer 16 is a known printer-processor (printing and developing unit) which, in accordance with the image data being output from the data converting section 66, exposes the photographic paper (light-sensitive material) to record a latent image, which is developed and otherwise treated to produce an image that is eventually output as a (finished) print. In a typical case, the printer 16 cuts the photographic paper according to the print size and performs back printing and the like; thereafter, the printer 16 records a latent image on the photographic paper by two-dimensional scan such that optical beams modulated in accordance with the image data (the image to be recorded) are deflected in a main scan direction as the photographic paper is moved in an auxiliary scan direction perpendicular to the main scan direction; the photographic paper bearing the latent image is subjected to specified wet processing schemes including color development, bleach-fixing and washing and then dried; the obtained prints are assorted in stacks.

The illustrated photoprinter 10 not only yields prints but it can also output image data as an image file. As an example, the photoprinter 10 records the image data processed with the image processor 14 on a CD-R (standard CD-R as above) as an image file of a JPEG (Joint Photographic Expert Group) format so as to output the image data as the CD-R (standard CD-R) having the image data recorded thereon, which is a standard process of outputting an image file.

The file processing section 68 is a site where this image file conversion processing is performed; typically, 3D-LUTs are used to effect conversion of the image data to that compatible with the outputting of a JPEG image file and the obtained image data is converted to a JPEG image file, which is recorded on the CD-R in the file outputting unit 17. The recorded image file is then output from the file outputting unit 17 as the standard CD-R. The recorded image file may be tagged to show that it is an image file in the standard CD-R produced from the printer 10. Note that the standard image file format is by no means limited to JPEG but that all conventional formats including Exif and JPEG 2000 can be employed.

The illustrated photoprinter 10 can also produce outputs other than the prints from the printer 16 as a standard accessory and the standard CD-Rs from the file outputting device 17; it can supply image data to other models of printer-processor, to different types of printer including an ink-jet printer and an electrophotographic printer, to (nonstandard) CD-R outputs of an image format other than JPEG, such as the bit-mapped format and GIF, as well as to media drives for recording on recording media other than CD-R (such devices being hereunder collectively referred to as output devices). In the present invention, the printer 16, the file outputting unit 17, and the output devices are the destinations of the processed image data The printer 16 and the file outputting unit 17 may be included in the output devices.

The device processing section 70 performs various processing steps in accordance with the output device to which the processed image data is to be eventually delivered, with the processing steps to be performed including transformation of image data such as a color space, its compression, image-formatting, and attachment of a tag indicating the deliverance of an output from the photoprinter 10; then the section 70 outputs the processed image data to the specified output device.

In the illustrated photoprinter 10, the image data need not be delivered to one output device only and it may be delivered to two or more output devices, namely two or more destinations to which the sharpening section 64 should output image data, at a time for the purpose of, for example, simultaneous output of a print and a standard CD-R.

As already mentioned, in the photoprinter 10, image data is supplied also from various input devices other than the scanner 12 and supplied also to various output devices other than the printer 16 and the standard CD-R.

The sharpening section 64 of the image processor 14 performs a sharpening process (image structure processing) on the supplied image data in a way compatible with the scanner 12 or another input device used, thereby producing an intermediate image having a specified image structure; the sharpening section 64 then performs a sharpening process on the intermediate image in a way compatible with the printer 16 (prints), the file outputting unit 17 (standard CD-Rs) or a specified output device.

FIG. 3 shows in concept the configuration of the sharpening section 64 and the processing that is performed in the sharpening section 64.

In one example, the illustrated photoprinter 10 can acquire image data not only from the scanner 12 but also from six other input devices comprising three types of film scanner that have different capabilities (scanner A, scanner B and scanner C), as well as three types of media drive, one for standard CD-Rs, one for recording media (media A) that store image data taken with a digital camera, and one for recording media (media B) that store image data processed with a computer or the like.

In another example, the illustrated photoprinter 10 can not only output prints from the printer 16 and output image data to the standard CD-R; it can also output image data to three different printers (printer A, printer B and printer C), as well as to a recording medium (media) designed for use with a computer through a media drive. Printer A may be a printer-processor of a different model than the printer 16; printer B may be an ink-jet printer; printer C may be an ink-jet printer of a different model than printer B.

In the sharpening section 64, sharpening conditions are set an such a way that in accordance with the characteristics of an image data supply source (input device) such as the scanner 12 and media A (the media drive for media A), an intermediate image can be obtained that has a specified image structure compatible with the image data supply source.

The sharpening section 64 also has sharpening conditions set in such a way that in accordance with the characteristics of an output device such as the printer 16 and printer A, an image having the optimum image structure for the output device, namely an image having less noise, e.g., suppressed graininess in the case of a film image, and appropriate sharpness, can be produced from the intermediate image.

In short, in the sharpening section 64, the image data as acquired from a specific input device is subjected to an input-device dependent sharpening process in the first sharpening device 64a to produce an intermediate image, which is then subjected to an output-device dependent sharpening process in the second sharpening device 64b, thereby producing an output image having the optimum image structure for a specific output device.

The specified structure of an intermediate image may appropriately be set as an image structure that is compatible with all possible input devices including the input device which is going to be selected as an image data supply source. Alternatively, the photoprinter 10 may select a single output device, set an image structure that is optimum for that output device and use it as the specified structure of an intermediate image.

In the illustrated case, the image structure intended for recording on the standard CD-R may be chosen as the specified structure of an intermediate image. Hence, whichever is the input device the image data is acquired from, the intermediate image will have the image structure for recording on the standard CD-R. Note that in one example, the image data for recording on the standard CD-R is primarily intended for image viewing on a monitor associated with a personal computer and an optimum image structure compatible with this specific case is the image structure intended for the standard CD-R, or the specified structure of an intermediate image.

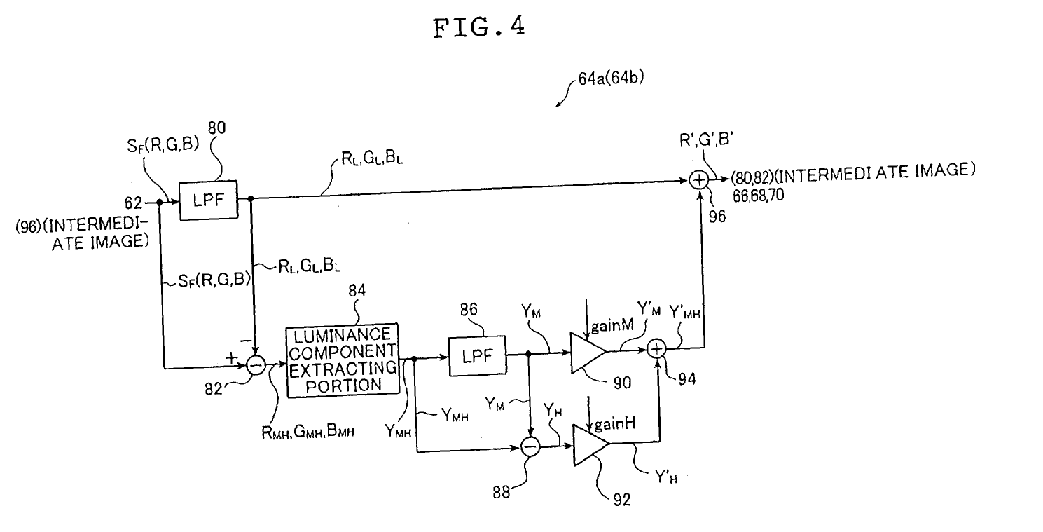

FIG. 4 shows a block diagram for an example of the sharpening device 64a/64b in the sharpening section 64. Since the sharpening devices 64a and 64b are the same in structure, only the sharpening device 64a will be described in the following as a representative.

As shown, the sharpening device 64a/64b comprises a first LPF 80, a first subtracter 82, a luminance component extracting portion 84, a second LPF 86, a second subtracter 88, a first amplifier 90, a second amplifier 92, a first adder 94 and a second adder 96.

In the illustrated sharpening device 64a, image data (hereunder designated as original signal S_{F}(R,G,B)) supplied from the image processing section 62 is first processed in the first LPF 80 to extract the low-frequency components R_{L}, G_{L} and B_{L} of the original signal S_{F}(R,G,B), which are then sent to the first subtracter 82 and the second adder 96. The first LPF 80 may be a 9×9 LPF.

The first subtracter 82 subtracts the low-frequency components R_{L}, G_{L} and B_{L} from the original signal S_{F}(R,G,B) to extract the medium- and high-frequency components R_{MH}, G_{MH} and B_{MH}. Thus, in the illustrated case, the image data is separated into two frequency component groups, one of the low-frequency components and the other of the medium- and high-frequency components.

In the next step, the luminance component extracting portion 84 extracts a luminance component Y_{MH} from the higher-frequency components, namely, the medium- and high-frequency components R_{MH}, G_{MH} and B_{MH} that have been obtained by the first subtracter 82. The luminance component Y_{MH} is obtained by transforming the medium- and high-frequency components R_{MH}, G_{MH} and B_{MH} in accordance with the YIQ scheme. In one example, the luminance component extracting portion 84 extracts (computes) the luminance component Y_{MH} by MTX operations.

Subsequently, the luminance component Y_{MH} extracted by the luminance component extracting portion 84 is subjected to filtering with the second LPF 86, thereby generating the medium-frequency component Y_{M} of the luminance component Y_{MH}. The second LPF 86 may be a 5×5 LPF.

In addition, the second subtracter 88 subtracts the medium-frequency component Y_{M} from the luminance component Y_{MH}, thereby generating the high-frequency component Y_{H} of the luminance component Y_{MH}.

Further, in the first amplifier 90, the medium-frequency component Y_{M} generated by the second LPF 86 is multiplied by a gain M whereas in the second amplifier 92, the high-frequency component Y_{H} generated by subtraction is multiplied by a gain H; as a result, two processed components Y′_{M} and Y′_{H} are obtained.

The two gains (sharpness gains) are set at different levels; gain M by which the medium-frequency component Y_{M} is to be multiplied is usually set comparatively low and gain H by which the high-frequency component Y_{M} is to be multiplied is set comparatively high. By these settings, one can obtain an image that is suppressed in noise (graininess) and which has desirably enhanced sharpness.

In the present invention, that is to say, in the illustrated sharpening device 64a, however, gains M and H are set in accordance with the input device, from which the image data to be subjected to a sharpening process is supplied, in order to perform an input-device dependent sharpening process as a feature of the present invention Subsequently, the processed components Y′_{M} and Y′_{H} obtained by the first amplifier 90 and the second amplifier 92, respectively, are combined in the first adder 94 to give a component Y′_{MH}.

Further, in the second adder 96, the thus obtained component Y′_{MH} is combined with the aforementioned low-frequency components R_{L}, G_{L} and B_{L} of the original signal S_{F} to produce image data R′, G′ and B′ in which the sharpness is enhanced in accordance with the input device.

The image data R′, G′ and B′ thus produced are regarded as the image data of the intermediate image obtained by performing the input-device dependent sharpening process.

The image data R′, G′ and B′ of the intermediate image are then supplied to the illustrated sharpening device 64b, initially as the original signal S_{F}(R,G,B). In the sharpening device 64b, the output-device dependent sharpening process as a feature of the present invention is performed following the same procedure as in the sharpening device 64a except for the use of gains M and H set in accordance with the output device to which the image data subjected to the sharpening process is to be output. As a consequence, the image data R′, G′ and B′ in which the sharpness is enhanced in accordance with the output device can be obtained.

As already mentioned, the image data R′, G′ and B′ thus obtained are supplied to at least one of three sections, i.e., the data converting section 66, file processing section 68 and device processing section 70.

In the photoprinter 10 (in particular, the image processor 14), given specific input and output devices, gains M and H compatible with the characteristics of those input and output devices are set as conditions for each of the input-device dependent sharpening process and the output-device dependent sharpening process.

As already mentioned, in the illustrated case, the image structure intended for recording on the standard CD-R is chosen as the specified structure of an intermediate image. The input-device dependent sharpening process is a step by which the input image is converted to an intermediate image having that specified structure.

Based on this, if the image captured with the scanner 12 is more noisy (grainy) and less sharp than the image to be recorded on the standard CD-R, processing conditions having a lower value of gain M but a higher value of gain H than in the processing for the standard CD-R are set as those for the input-device dependent sharpening process that is compatible with the scanner 12. If the image recorded in the media A (digital camera) is less noisy and sharp than the image to be recorded on the standard CD-R, processing conditions having higher values of both gains M and H than in the processing for the standard CD-R are set as those for the input-device dependent sharpening process that is compatible with the media A. If the scanner A is a device that performs sharpening in its interior and if the image it captures is more noisy but sharper, processing conditions having lower values of both gains M and H than in the processing for the standard CD-R are set as those for the input-device dependent sharpening process that is compatible with the scanner A.

Thus, the conditions for the input-device dependent sharpening process are set to be compatible with a specific input device such that they cancel those characteristics of the input device which are more or less incongruous with the image (intermediate image) to be recorded on the standard CD-R.

On the other hand, the conditions for the output-device dependent sharpening process are set to be compatible with a specific output device such that the image obtained by processing the image (intermediate image) in the standard CD-R will have a structure optimum for the specific output device.

For example, if it is preferred for the printer 16 to produce an image that is sharper and less noisy (less grainy), processing conditions having a lower value of gain M but a higher value of gain H are set as those for the output-device dependent sharpening process that is compatible with the printer 16. If it is preferred for the printer B (ink-jet printer) to produce an image that is significantly suppressed in noise, processing conditions having a lower setting of gain M are set as those for the output-device dependent sharpening process that is compatible with the printer B.

As in the case of the conditions for the input-device dependent sharpening process, if the standard CD-R is chosen as the output device, “no processing” is set as the condition for the output-device dependent sharpening process. In the case where a standard CD-R is chosen as the input or output device, while “no processing” may be set as the condition for the input- or output-device dependent sharpening process, it is also possible to allow the image data to skip the sharpening device 64a or 64b.

Upon receiving the image data from the image processing section 62, in the sharpening section 64, an intermediate image is generated by performing the input-device dependent sharpening process in the sharpening device 64a shown in FIG. 4, with gains M and H being set to have values compatible with the specified input device. In order to help the sharpening section 64 identify where the input image data was supplied from, any known method may be employed as exemplified by attaching to the image data a tag that indicates its supply source.

In the sharpening section 64, the generated intermediate image is subjected to the output-device dependent sharpening process in the sharpening device 64b also shown in FIG. 4, with gains M and H being set to have values compatible with the designated output device. Depending on where the output image data is to be eventually delivered to, the sharpened image data is output to either the data converting section 66 (if the output device is the printer 16) or the file processing section 68 (the standard CD-R) or the device processing section 70 (any other output device).

Thus, according to the invention, high-quality image having an appropriate structure can be output to any one of possible output devices irrespective of where image data is input from (its supply source).

In the embodiment described above, the gains to be employed in the sharpening process are altered in accordance with the characteristics of the chosen input and output devices. This is not the sole case of the invention and the frequency characteristics of the LPFs may be altered in accordance with the characteristics of the chosen input and output devices. If desired, the alteration of the gains may be combined with that of the frequency characteristics of the LPFs.

The scheme of the sharpening process (its algorithm) is not limited to the above-described embodiment and various other schemes may be employed. For example, a so-called unsharp mask may be employed to calculate the average and the difference from it may be multiplied by a coefficient, with the product being added to the image data.

If desired, a plurality of executable sharpening schemes may be provided and a suitable one is chosen in accordance with the characteristics of the input and output devices.

There is no complete assurance that the structure of the intermediate image will appropriately fit every possible input device at all times. If this is the case, the intermediate image does not have an appropriate structure, potentially producing an output image having an inappropriate structure.

To deal with this possibility, the conditions for the output-device dependent sharpening process may be altered in accordance with the specified input device; for example, if the image data acquired from the scanner A is to be eventually output to the printer 16, the output-device dependent sharpening process may be performed under specified conditions that are compatible with the printer 16 and if the image data acquired from the scanner B is to be output to the printer 16, the output-device dependent sharpening process may be performed under conditions different from the specified conditions that are compatible with the printer 16. In this case, in order to help identify where the input image data was supplied from, any suitable method may be employed as exemplified by attaching to the intermediate image a tag that indicates the supply source of the input image data.

In order to accommodate these processing schemes, a tag indicating that image data was created in the photoprinter 10 may be attached to the image file when the image data is output to a media.

The configurations of the image processing method according to the first aspect of the present invention and the image processing apparatus according to the second aspect of the present invention are basically as described above, although the present invention is in no way limited thereto. The image processing method according to the first aspect of the present invention as above may be implemented as an image processing program executed in a computer as is the case of the third aspect of the present invention.

While the image processing method, the image processing apparatus and the image processing program of the present invention have been described above in detail with reference to various embodiments and examples, it should be noted that the invention is by no means limited to such embodiments and examples but various improvements and modifications may of course be made without departing from the scope and spirit of the invention.

As described above in detail, according to the present invention, there is provided an image processing method in which image data is acquired and subjected to image structure processing for subsequent outputting and which can output an image of the appropriate structure, namely, an image having less noise and satisfactory sharpness irrespective of where the image is supplied from and where it is eventually output to.

What is claimed is:

1. An image processing method, comprising the steps of:
acquiring image data from an image data supply source;
subjecting the thus acquired image data to a first image structure processing scheme that has been set in accordance with characteristics of said image data supply source; and
thereafter subjecting the thus subjected image data to a second image structure processing scheme that has been set in accordance with characteristics of an output site to which said image data subjected to the second image structure processing scheme is delivered.

2. The image processing method according to claim 1, wherein said first image structure processing scheme is an image structure processing scheme by which an image carried by said acquired image data is converted to an intermediate image having a specified image structure.

3. The image processing method according to claim 2, wherein said intermediate image is an image having an image structure compatible with a preliminarily chosen output site.

4. The image processing method according to claim 2, wherein said intermediate image is an image obtained by removing a noise component or graininess derived from said image data supply source, an image obtained by converting an MTF (Modulation Transfer Function) characteristic of said image data supply source so that it may match a reference intermediate MTF characteristic which is preliminarily set, or an image obtained by removing the noise component or graininess derived from said image data supply source and, concurrently therewith, converting the MTF characteristic of said image data supply source so that it may match the reference intermediate MTF characteristic which is preliminarily set.

5. The image processing method according to claim 1, wherein said first image structure processing scheme includes removal of a noise component derived from said image data supply source.

6. The image processing method according to claim 5, wherein said image data supply source is a scanner for capturing an image recorded on a photographic film, said image data is image data captured with said scanner from said image recorded on a photographic film, and said noise component is graininess.

7. The image processing method according to claim 1, wherein said first image structure processing scheme includes frequency processing in which an MTF characteristic of said image data supply source is converted so that it may match a reference intermediate MTF characteristic which is preliminarily set.

8. The image processing method according to claim 1, wherein, in said first image structure processing scheme, a noise component or graininess derived from said image data supply source is removed and, concurrently therewith, frequency processing is so performed that an MTF characteristic of said image data supply source is converted so that it may match a reference intermediate MTF characteristic which is preliminarily set.

9. The image processing method according to claim 1, wherein said second image structure processing scheme includes frequency processing in which an output MTF characteristic is calculated from a reference output MTF characteristic which is preliminarily set, an MTF characteristic of said output site, and viewing conditions and a reference intermediate MTF characteristic which is preliminarily set is converted so that it may match the output MTF characteristic thus calculated.

10. The image processing method according to claim 9, wherein said viewing conditions include output size and viewing distance.

11. An image processing apparatus comprising:
image data acquiring means for acquiring image data from an image data supply source;
a first image structure processing means for subjecting the image data acquired with the image data acquiring means to a first image structure processing scheme that has been set in accordance with characteristics of said image data supply source; and
a second image structure processing means for subjecting the image data subjected to said first image structure processing scheme by the first image structure processing means to a second image structure processing scheme that has been set in accordance with characteristics of an output site to which said image data subjected to the second image structure processing scheme is delivered.

12. The image processing apparatus according to claim 11, wherein said first image structure processing means converts an image carried by said acquired image data to an intermediate image having a specified image structure.

13. The image processing apparatus according to claim 11, wherein said first image structure processing means removes a noise component or graininess derived from said image data supply source.

14. The image processing apparatus according to claim 11, wherein said first image structure processing means performs frequency processing in which an MTF characteristic of said image data supply source is converted so that it may match a reference intermediate MTF characteristic which is preliminarily set.

15. The image processing apparatus according to claim 11, wherein said second image structure processing means performs frequency processing in which an output MTF characteristic is calculated from a reference output MTF characteristic which is preliminarily set, an MTF characteristic of said output site, and viewing conditions and a reference intermediate MTF characteristic which is preliminarily set is converted so that it may match the output MTF characteristic thus calculated.

16. An image processing program for implementing an image processing method, said image processing method comprising the steps of:
acquiring image data from an image data supply source;
subjecting the thus acquired image data to a first image structure processing scheme that has been set in accordance with characteristics of said image data supply source; and
thereafter subjecting the thus subjected image data to a second image structure processing scheme that has been set in accordance with characteristics of an output site to which said image data subjected to the second image structure processing scheme is delivered.
